(19) United States
(12) Patent Application Publication
(10) Pub. No.: US 2026/0178523 A1
(43) Pub. Date: Jun. 25, 2026

(54) LOG MANAGEMENT APPARATUS, IN-VEHICLE SYSTEM, AND DATA TRANSFER METHOD FOR LOG MANAGEMENT APPARATUS

(71) Applicant: Renesas Electronics Corporation, Tokyo (JP)

(72) Inventor: Kosuke KASASHIMA, Tokyo (JP)

(21) Appl. No.: 19/360,098

(22) Filed: Oct. 16, 2025

(30) Foreign Application Priority Data
Dec. 24, 2024 (JP) 2024-227026

(51) Int. Cl. G06F 13/28

(52) U.S. Cl. CPC G06F 13/28; G06F 2213/28

(57) ABSTRACT

A log management apparatus, an in-vehicle system, and a data transfer method for the log management apparatus are provided to preferentially transfer desired log data to a storage. The log management apparatus 1 includes a CPU 2 that outputs log data, a log buffer 41 that stores log data, and a DMA controller 3 that transfers the log data stored in the log buffer 41 to a storage 5. The DMA controller 3 includes a priority table storage unit 31 that stores a priority table including a priority set that determines a priority for each tag associated with log data, and a transfer necessity determination circuit 32 that determines which log data not to be transferred to the storage 5 from among the log data stored in the log buffer 41 based on the priority set.

### CROSS-REFERENCE TO RELATED APPLICATIONS

The disclosure of Japanese Patent Application No. 2024-227026 filed on December 24, 2024, including the specification, drawings and abstract is incorporated herein by reference in its entirety.

### BACKGROUND

The present invention relates to a log management apparatus, an in-vehicle system, and a data transfer method for the log management apparatus.

In autonomous driving systems, a log data collection mechanism (data recorder) that preserves internal system information is crucial for identifying the cause of accidents. Particularly in recent years, with the advancement and enhancement of autonomous driving technology, a large amount of log data is generated within the system, necessitating a mechanism in the data recorder to efficiently collect this data. Additionally, in the data recorder, various data transfer methods may be used when transferring log data. One such data transfer method is Direct Memory Access (DMA) transfer. DMA transfer is a method of directly transferring data between storage devices such as a RAM (Random Access Memory) and a storage without involving a Central Processing Unit (CPU).

There are disclosed techniques listed below.

[Patent Document 1] Japanese Unexamined Patent Application Publication No. 2006-302128

Patent Document 1 discloses an information processing device that executes data transfer using DMA transfer. The information processing device in Patent Document 1 includes a message box for storing messages received from a slow Controller Area Network (CAN) bus, a memory connected to a high-speed CPU bus, and a DMA controller that transfers messages stored in the message box to the memory via DMA transfer.

### SUMMARY

Patent Document 1 discloses the DMA transfer from the message box on the slow bus side to the memory on the high-speed bus side. That is, the DMA transfer disclosed in Patent Document 1 assumes that the data transfer speed to the destination memory is greater than the data storage speed to the source message box, so it is not anticipated that messages waiting for transfer stored in the message box will be lost due to being overwritten by newly stored messages.

However, in data recorders, there may be cases where log data output from the CPU is the target for collection. In this case, the data recorder stores the log data output from the CPU in a RAM connected to a high-speed CPU bus and transfers the log data stored in the RAM to a storage connected to a slow bus via DMA transfer. In such a data recorder, the data storage speed exceeds the data transfer speed, which may result in log data waiting for transfer being overwritten by newly stored log data, leading to a situation where the log data necessary for analysis cannot be secured.

Other objects and novel features will become apparent from the description of this specification and the accompanying drawings.

A log management apparatus according to one embodiment includes a CPU that outputs log data, a log buffer that stores log data, and a DMA controller that transfers the log data stored in the log buffer to a storage. The DMA controller includes a priority table storage unit that stores a priority table including a priority set that determines a priority for each tag associated with log data, and a transfer necessity determination circuit that determines which log data not to be transferred to the storage from among the log data stored in the log buffer based on the priority set.

A data transfer method for a log management apparatus according to one embodiment includes storing log data output from a CPU in a log buffer and transferring the log data stored in the log buffer to a storage. Additionally, the data transfer method for the log management apparatus includes storing a priority table including a priority set that determines a priority for each tag associated with log data in a priority table storage unit and determining which log data not to be transferred to the storage from among the log data stored in the log buffer based on the priority set.

According to the present disclosure, even when a large amount of log data is generated, the desired log data among them is preferentially transferred to a storage. This reduces the risk of situations where the log data necessary for analysis cannot be secured.

### BRIEF DESCRIPTION OF THE DRAWINGS

FIG. 1 is a block diagram illustrating a log management apparatus according to a first embodiment.

FIG. 2 is a block diagram illustrating the log management apparatus according to the first embodiment.

FIG. 3 is a diagram for explaining an example of a priority table according to the first embodiment.

FIG. 4 is a flowchart illustrating the operation of writing log data to a log buffer according to the first embodiment.

FIG. 5 is a flowchart illustrating the DMA transfer operation of log data from the log buffer to a storage according to the first embodiment.

FIG. 6 is a flowchart illustrating the operation for determining a non-transfer address of log data according to the first embodiment.

FIG. 7 is a block diagram illustrating a log management apparatus according to a second embodiment.

FIG. 8 is a diagram for explaining an example of a priority table according to the second embodiment.

FIG. 9 is a flowchart illustrating the operation of a priority set selection circuit according to the second embodiment.

FIG. 10 is a block diagram illustrating a log management apparatus according to a third embodiment.

FIG. 11 is a flowchart illustrating the operation of a priority set selection circuit according to the third embodiment.

### DETAILED DESCRIPTION

For the sake of clarity in the explanation, the following descriptions and drawings are appropriately omitted and simplified. In each drawing, the same elements are denoted by the same reference numerals, and repetitive descriptions are omitted as necessary.

### First Embodiment

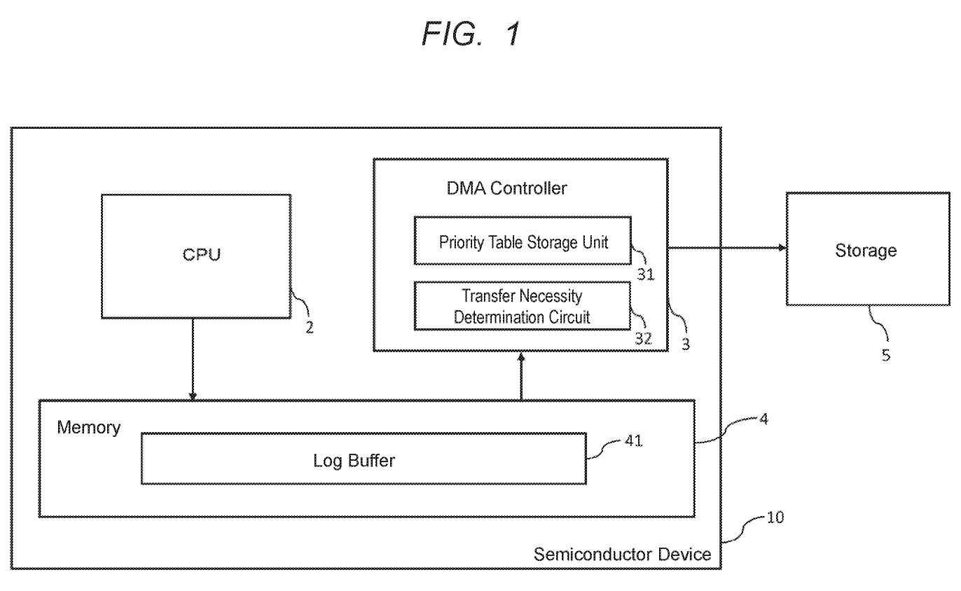

FIG. 1 is a block diagram illustrating the configuration of a log management apparatus 1 according to a first embodiment. As shown in FIG. 1, the log management apparatus 1 includes a semiconductor device 10 and a storage 5. The Semiconductor device 10 includes a CPU 2, a DMA controller 3, and a memory 4.

The CPU 2 is connected to the memory 4 and outputs log data generated in response to the execution of applications to the memory 4. The memory 4 is configured, for example, by a Dynamic Random Access Memory (DRAM). Additionally, the memory 4 has a log buffer 41, which is an area for storing log data output from the CPU 2.

The DMA controller 3 is connected to the memory 4 and the storage 5 and transfers the log data stored in the log buffer 41 of the memory 4 to the storage 5. The DMA controller 3 also includes a priority table storage unit 31 and a transfer necessity determination circuit 32. The priority table storage unit 31 stores a priority table that includes a priority set determining a priority for each tag associated with log data. The transfer necessity determination circuit 32 determines which log data not to be transferred to the storage 5 from among the log data stored in the log buffer 41 based on the priority set when it is determined that there is insufficient space to write log data in the log buffer 41.

The storage 5 is connected to the semiconductor device 10 and is configured, for example, by a Solid State Drive (SSD) utilizing a non-volatile memory in a data retention area. The storage 5 stores the log data output from the semiconductor device 10.

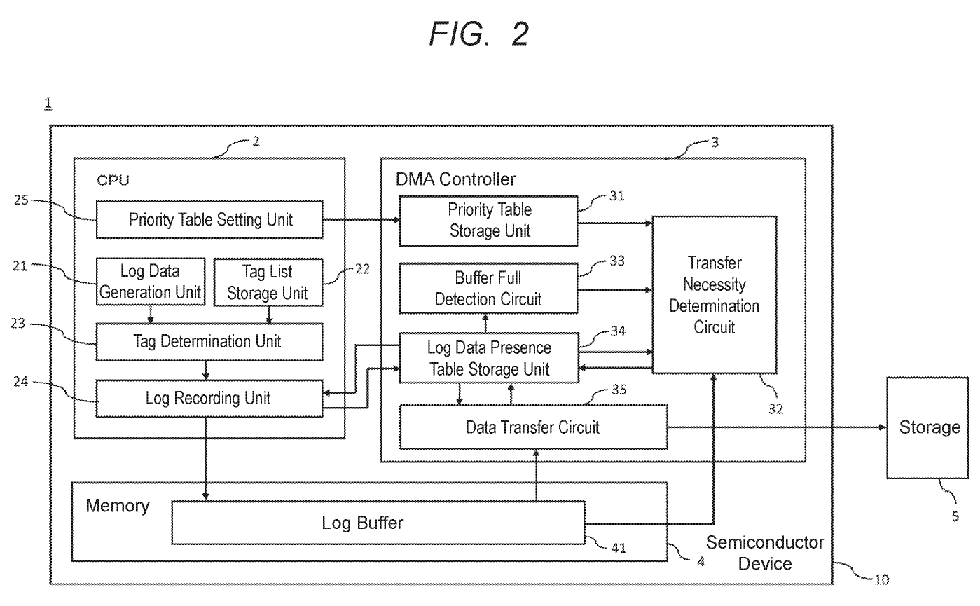

FIG. 2 is a block diagram illustrating the detailed configuration of the log management apparatus 1 according to the first embodiment. As shown in FIG. 2, the CPU 2 includes a log data generation unit 21, a tag list storage unit 22, a tag determination unit 23, a log recording unit 24, and a priority table setting unit 25. The DMA controller 3 includes the priority table storage unit 31, the transfer necessity determination circuit 32, a buffer full detection circuit 33, a log data presence table storage unit 34, and a data transfer circuit 35. The memory 4 includes the log buffer 41.

The tag list storage unit 22, the priority table storage unit 31, and the log data presence table storage unit 34 are configured, for example, by a Static Random Access Memory (SRAM). The log data generation unit 21, the tag determination unit 23, the log recording unit 24, and the priority table setting unit 25 are functional blocks realized by the CPU 2 executing a control program. Note that all or part of the log data generation unit 21, the tag determination unit 23, the log recording unit 24, and the priority table setting unit 25 can also be configured as circuit blocks. Additionally, all or part of the transfer necessity determination circuit 32 and the buffer full detection circuit 33 may be replaced with functional blocks realized by the CPU 2 executing a control program.

The log data generation unit 21 generates log data in response to the execution of applications. The tag list storage unit 22 stores a tag list for classifying log data. The tag determination unit 23 is connected to the log data generation unit 21 and the tag list storage unit 22 and associates the log data generated by the log data generation unit 21 with tags based on the tag list stored in the tag list storage unit 22. The tag determination unit 23 outputs the log data associated with the tags to the log recording unit 24.

The log recording unit 24 is connected to the tag determination unit 23 and receives the log data associated with the tags from the tag determination unit 23. The log recording unit 24 is also connected to the log data presence table storage unit 34 and writes the log data associated with the tags into the free space of the log buffer 41 by referring to the log data presence table stored in the log data presence table storage unit 34.

The log data presence table storage unit 34 stores the log data presence table including the addresses of the log buffer 41 and flags associated with the addresses of the log buffer 41. The flag indicates whether log data to be transferred to the storage 5 has been written to the address of the log buffer 41 associated with the flag. The flag can take either a first value or a second value. For example, if the flag is composed of 1 bit, the first value corresponds to 1, and the second value corresponds to 0. When the flag is set to 1, it indicates that log data to be transferred to the storage 5 is stored at the associated address of the log buffer 41. On the other hand, when the flag is not set to 1, in other words, when the flag is cleared to 0, it indicates that log data to be transferred to the storage 5 is not stored at the associated address of the log buffer 41.

When writing log data into the log buffer 41, the log recording unit 24 accesses the log data presence table storage unit 34. The log recording unit 24 identifies the flag in the log data presence table that is not set to 1 and obtains the address of the log buffer 41 associated with the identified flag as the free space of the log buffer 41. The log recording unit 24 accesses the log buffer 41 of the memory 4 and writes the log data associated with the tag into the obtained address (free space) of the log buffer 41. After the completion of the writing of the log data into the log buffer 41, the log recording unit 24 accesses the log data presence table storage unit 34 again. The log recording unit 24 updates the log data presence table by setting the flag associated with the address of the log buffer 41 where the writing has been completed to 1.

The log buffer 41 stores log data in association with tags. The speed at which log data is written from the CPU 2 to the log buffer 41 may be faster than the speed at which log data is transferred from the log buffer 41 to the storage 5.

The buffer full detection circuit 33 is connected to the log data presence table storage unit 34 and monitors the flags in the log data presence table. The buffer full detection circuit 33 generates a buffer full signal when it detects that all flags in the log data presence table are set to 1. Additionally, the buffer full detection circuit 33 is connected to the transfer necessity determination circuit 32 and outputs the buffer full signal to the transfer necessity determination circuit 32. The buffer full signal is not limited to being generated only when it is confirmed that all flags in the log data presence table are set to 1. For example, the buffer full detection circuit 33 may generate a buffer full signal when it detects that the free space for writing new log data to the log buffer 41 has become less than a predetermined amount. In this way, the buffer full signal serves as a warning signal for insufficient space to write log data to the log buffer 41.

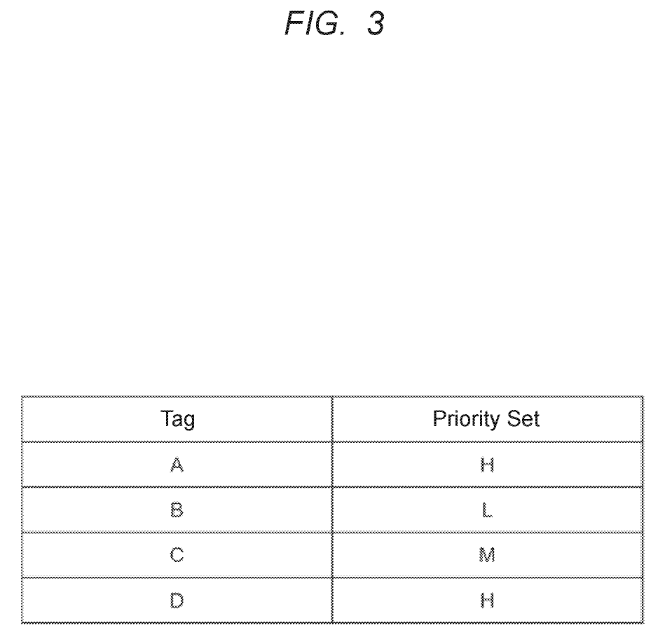

The priority table storage unit 31 stores a priority table that includes a priority set that determines the priority for each tag associated with log data. FIG. 3 is a diagram for explaining an example of the priority table according to the first embodiment. As shown in FIG. 3, the priority set is configured by priorities set for each of tags A to D. The priorities are expressed in three levels, for example, H, M, and L, corresponding to High, Middle, and Low, respectively. In the example shown in FIG. 3, the priorities for tags A and D are set to H (High), the priority for tag B is set to L (Low), and the priority for tag C is set to M (Middle).

The priority table setting unit 25 is connected to the priority table storage unit 31. The priority table setting unit 25 sets the priority table stored in the priority table storage unit 31 based on information from the user.

The transfer necessity determination circuit 32 is connected to the priority table storage unit 31, the buffer full detection circuit 33, the log data presence table storage unit 34, and the log buffer 41. The transfer necessity determination circuit 32 determines that there is insufficient space to write log data in the log buffer 41 in response to the generation of a buffer full signal. Upon receiving the buffer full signal from the buffer full detection circuit 33, the transfer necessity determination circuit 32 accesses the priority table storage unit 31. The transfer necessity determination circuit 32 obtains the priority for each tag from the priority set included in the priority table. The transfer necessity determination circuit 32 refers to the obtained priority for each tag to identify at least one tag as a low-priority tag.

Furthermore, the transfer necessity determination circuit 32 accesses the log data presence table storage unit 34 and identifies the flag set to 1 in the log data presence table. The transfer necessity determination circuit 32 obtains the address of the log buffer 41 associated with the identified flag set to 1. The transfer necessity determination circuit 32 accesses the memory 4 and reads the tag stored in the log buffer 41 using the obtained address of the log buffer 41.

The transfer necessity determination circuit 32 determines the address of the log buffer 41 from which a low-priority tag has been read as a non-transfer address by comparing the tag read from the log buffer 41 with the low-priority tag identified based on the priority table. The non-transfer address indicates the address of the log buffer 41 where log data not to be transferred to the storage 5 is stored. The transfer necessity determination circuit 32 accesses the log data presence table storage unit 34 again and changes (clears) the value of the flag associated with the address of the log buffer 41 determined as the non-transfer address in the log data presence table to 0. In this way, the transfer necessity determination circuit 32 determines the log data not to be transferred from the log buffer 41 to the storage 5 by changing the value of the flag in the log data presence table from 1 to 0.

The data transfer circuit 35 is connected to the log data presence table storage unit 34, the log buffer 41, and the storage 5. The data transfer circuit 35 executes DMA transfer of log data from the log buffer 41 to the storage 5. Specifically, the data transfer circuit 35 accesses the log data presence table storage unit 34 and identifies the flag set to 1 in the log data presence table. The data transfer circuit 35 obtains the address of the log buffer 41 associated with the identified flag set to 1. The data transfer circuit 35 accesses the memory 4 and reads the log data stored in the log buffer 41 of the memory 4 using the obtained address of the log buffer 41. The data transfer circuit 35 transfers the read log data to the storage 5.

Additionally, after the completion of the DMA transfer of log data from the log buffer 41 to the storage 5, the data transfer circuit 35 accesses the log data presence table storage unit 34. The data transfer circuit 35 changes (clears) the value of the flag associated with the address of the log buffer 41 where the log data for which the DMA transfer has been completed is stored to 0 in the log data presence table. In this way, by changing the flag value in the log data presence table from 1 to 0, the address of the log buffer 41 where the log data that has been transferred to the storage 5 is stored is recognized as free space.

The storage 5 is connected to the data transfer circuit 35 and receives the DMA-transferred log data. The storage 5 stores the received log data in the data retention area.

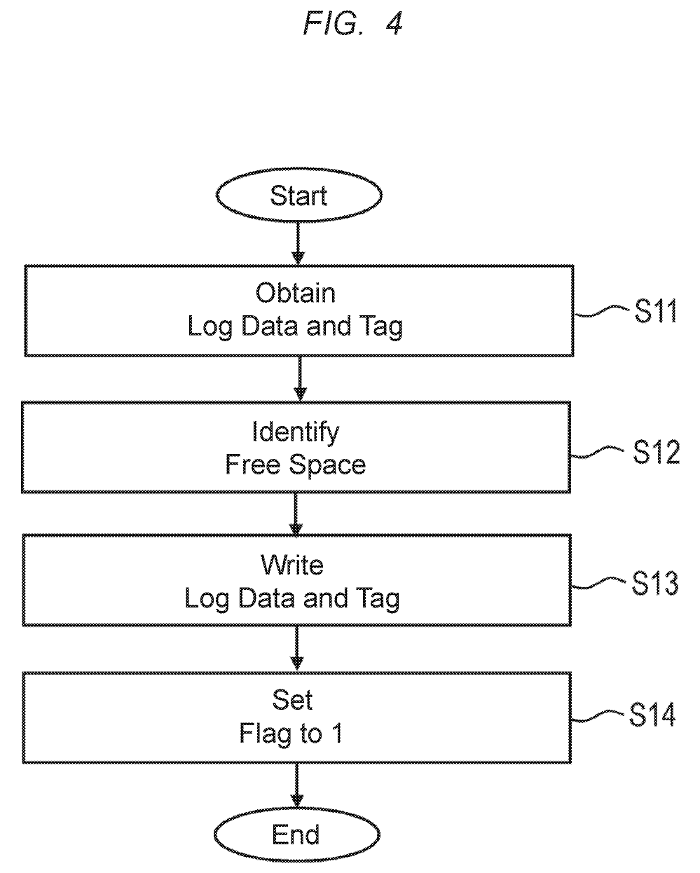

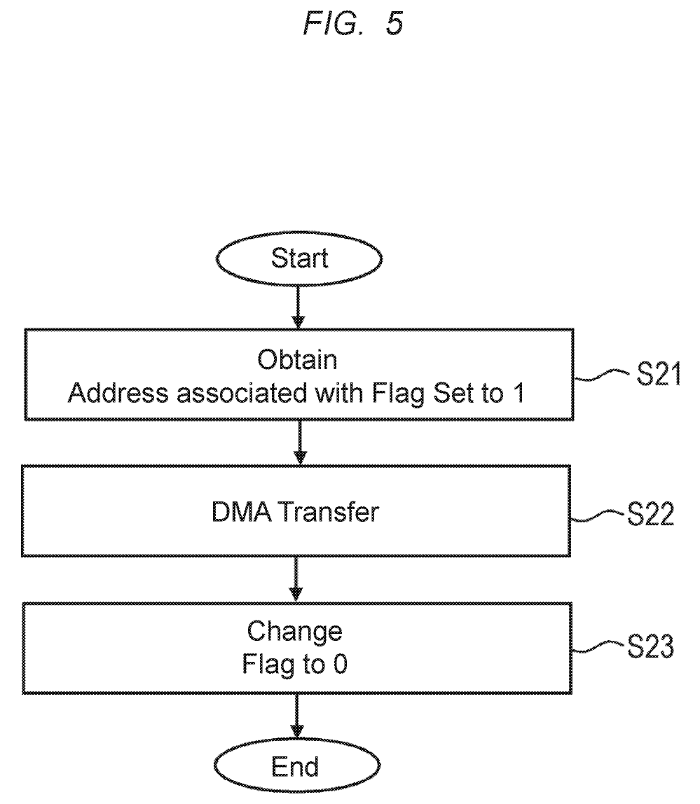

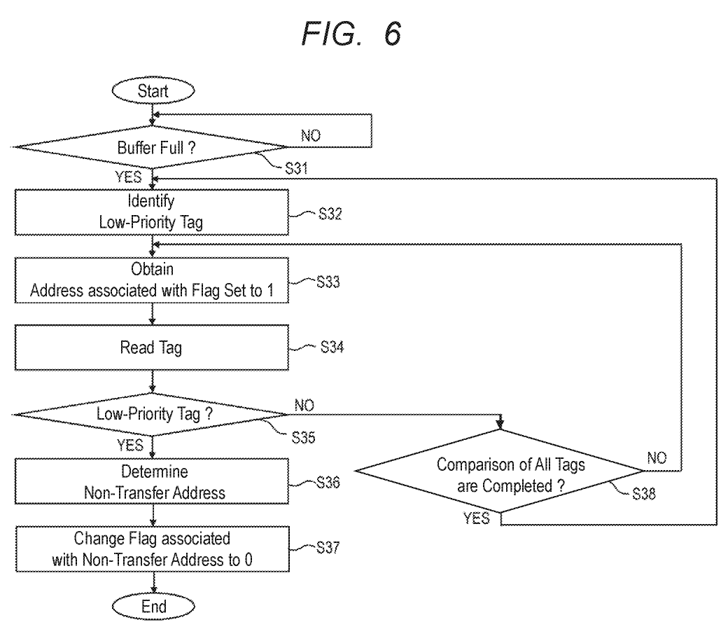

Next, the operation of the log management apparatus 1 according to the first embodiment will be described with reference to FIGS. 4 to 6. FIG. 4 is a flowchart illustrating the operation of writing log data to the log buffer 41 according to the first embodiment. FIG. 5 is a flowchart illustrating the DMA transfer operation of log data from the log buffer 41 to the storage 5 according to the first embodiment. FIG. 6 is a flowchart illustrating the operation for determining the non-transfer address of log data according to the first embodiment.

First, referring to FIG. 4, the operation of writing log data to the log buffer 41 in the log management apparatus 1 will be described. In a step S11, the log recording unit 24 obtains log data associated with a tag output from the tag determination unit 23.

In a step S12, the log recording unit 24 refers to the log data presence table to identify free space for writing the log data associated with the tag. Specifically, the log recording unit 24 reads the address of the log buffer 41 and the flag associated with it from the log data presence table stored in the log data presence table storage unit 34. The log recording unit 24 executes the reading process until it confirms a flag that is not set to 1. When the log recording unit 24 reads a flag that is not set to 1, it identifies the address of the log buffer 41 associated with the flag as free space.

In a step S13, the log recording unit 24 writes the log data associated with the tag into the free space of the log buffer 41. The log recording unit 24 may also write log data including a timestamp into the log buffer 41.

In a step S14, after the completion of the writing of the log data to the log buffer 41, the log recording unit 24 accesses the log data presence table storage unit 34 again to update the flag. The log recording unit 24 sets the flag associated with the address of the log buffer 41 where the writing has been completed in the log data presence table to 1. This changes the address of the log buffer 41 associated with the flag from free space to a storage area where log data before being transferred to the storage 5 is stored.

Next, referring to FIG. 5, the DMA transfer operation of log data from the log buffer 41 to the storage 5 in the log management apparatus 1 will be described. In a step S21, the data transfer circuit 35 reads the address of the log buffer 41 and the flag associated with it from the log data presence table stored in the log data presence table storage unit 34. By confirming the read flag, the data transfer circuit 35 obtains the address of the log buffer 41 associated with the flag set to 1. This reading process is performed until a flag set to 1 is read.

In a step S22, the data transfer circuit 35 executes the DMA transfer process. Specifically, the data transfer circuit 35 reads the log data stored in the log buffer 41 using the address of the log buffer 41 obtained in the step S21. The data transfer circuit 35 transfers the read log data to the storage 5. The address of the storage 5, which is the destination of the log data transfer, may be pre-set in the data transfer circuit 35 by the CPU 2.

In a step S23, the data transfer circuit 35 accesses the log data presence table storage unit 34 again to update the flag. The data transfer circuit 35 changes (clears) the value of the flag associated with the address of the log buffer 41 where the DMA-transferred log data is stored to 0 in the log data presence table. This releases the address of the log buffer 41 associated with the flag as free space for storing new log data.

Next, referring to FIG. 6, the operation for determining a non-transfer address of log data in the log management apparatus 1 will be described. In a step S31, the transfer necessity determination circuit 32 confirms whether it has received a buffer full signal warning of insufficient space for writing new log data to the log buffer 41 from the buffer full detection circuit 33. If the transfer necessity determination circuit 32 confirms that it has received the buffer full signal (YES in the step S31), the process proceeds to a step S32. If the transfer necessity determination circuit 32 confirms that it has not received the buffer full signal (NO in step S31), the process repeats the step S31.

In step the S32, the transfer necessity determination circuit 32 accesses the priority table stored in the priority table storage unit 31. The transfer necessity determination circuit 32 obtains the priority for each tag set in the priority set within the priority table. The transfer necessity determination circuit 32 refers to the obtained priority for each tag and identifies at least one tag as a low-priority tag. In the case of the priority table shown in FIG. 3, the transfer necessity determination circuit 32, for example, identifies the tag B, which is set with priority L, as a low-priority tag.

In step a S33, the transfer necessity determination circuit 32 reads the address of the log buffer 41 and the flag associated with it from the log data presence table stored in the log data presence table storage unit 34. By confirming the read flag, the transfer necessity determination circuit 32 obtains the address of the log buffer 41 associated with the flag set to 1. This reading process is performed until a flag set to 1 is read.

In a step S34, the transfer necessity determination circuit 32 reads the tag stored in the log buffer 41 using the address of the log buffer 41 obtained in the step S33.

In a step S35, the transfer necessity determination circuit 32 compares the tag read from the log buffer 41 with the low-priority tag identified in the step S32. If the tag read from the log buffer 41 matches the low-priority tag (YES in the step S35), the process proceeds to a step S36. On the other hand, if the tag read from the log buffer 41 does not match the low-priority tag (NO in the step S35), the process proceeds to a step S38.

In the step S36, the transfer necessity determination circuit 32 determines the address of the log buffer 41, from which a tag matching the low-priority tag is read, as a non-transfer address where log data not to be transferred to the storage 5 is stored.

In a step S37, the transfer necessity determination circuit 32 accesses the log data presence table storage unit 34 and changes (clears) the value of the flag associated with the address of the log buffer 41 determined as the non-transfer address in the log data presence table to 0. That is, the value of the flag associated with the address of the log buffer 41 obtained in the step S33 is changed from 1 to 0. As a result, the address of the log buffer 41 associated with the flag is treated as a free space, and the stored log data becomes data not to be transferred to the storage 5.

In the step S38, the transfer necessity determination circuit 32 confirms whether the comparison of all tags read using the address associated with the flag set to 1 with the low-priority tag identified in the step S32 is complete. If the transfer necessity determination circuit 32 confirms that the comparison process of all tags read using the address associated with the flag set to 1 with the low-priority tag identified in the step S32 is complete (YES in the step S38), the process returns to the step S32. In the second step S32, the transfer necessity determination circuit 32 refers to the priority set in the priority table to identify another tag as a low-priority tag. For example, if the transfer necessity determination circuit 32 identified the tag B with priority L as a low-priority tag in the first instance, it identifies the tag C with priority M as a low-priority tag in the second instance. In this way, the tag identified as a low-priority tag may be selected in order from the tags with lower priority, or it may be selected from among the tags excluding high-priority tags such as the tags A and D with priority H.

On the other hand, if the transfer necessity determination circuit 32 confirms that the comparison process of all tags read using the address associated with the flag set to 1 with the low-priority tag identified in the step S32 is not complete (NO in the step S38), the process returns to the step S33. In the second step S33, the transfer necessity determination circuit 32 obtains another address of the log buffer 41 by confirming the flags that have not yet been read from the log data presence table.

Note that if the log recording unit 24 writes log data including a timestamp into the log buffer 41, a non-transfer address may be determined by considering the timestamp. Specifically, in the step S33, the transfer necessity determination circuit 32 obtains a plurality of addresses of the log buffer 41 associated with the flag set to 1. In the step S34, the transfer necessity determination circuit 32 reads a plurality of tags stored in the log buffer 41 using the plurality of addresses of the log buffer 41. Additionally, the timestamp included in the log data associated with the tag is read together with the tag. In the step S35, the transfer necessity determination circuit 32 compares the plurality of tags read from the log buffer 41 with the low-priority tag identified in the step S32. In the step S36, the transfer necessity determination circuit 32 identifies the plurality of addresses of the log buffer 41 from which tags matching the low-priority tag are read. The transfer necessity determination circuit 32 determines, from among the identified addresses of the log buffer 41, the address of the log buffer 41 where the log data including the oldest timestamp is stored, as a non-transfer address where log data not to be transferred to the storage 5 is stored. By considering the timestamp when determining the non-transfer address in this way, it is possible to determine the log data not to be transferred to the storage 5 from the old log data.

As described above, the log management apparatus 1 according to the first embodiment includes the DMA controller 3 including the priority table storage unit 31 that stores the priority table, and the transfer necessity determination circuit 32 that determines log data not to be transferred from the log buffer 41 to the storage 5. When it is determined that there is insufficient space to write log data in the log buffer 41, the transfer necessity determination circuit 32 determines the log data not to be transferred to the storage 5 from among the log data stored in the log buffer 41 based on the priority set included in the priority table. This allows the desired log data to be preferentially transferred to the storage 5 even when a large amount of log data is generated, thereby reducing the risk of situations where the log data necessary for analysis cannot be secured.

### Second Embodiment

A second embodiment will be described. When saving log data in an in-vehicle system, it is considered that the log data to be saved changes according to the state of the vehicle. Therefore, in the log management apparatus according to the second embodiment, the priority of the tag associated with the log data can be changed according to the state of the vehicle so that the desired log data is transferred to the storage 5.

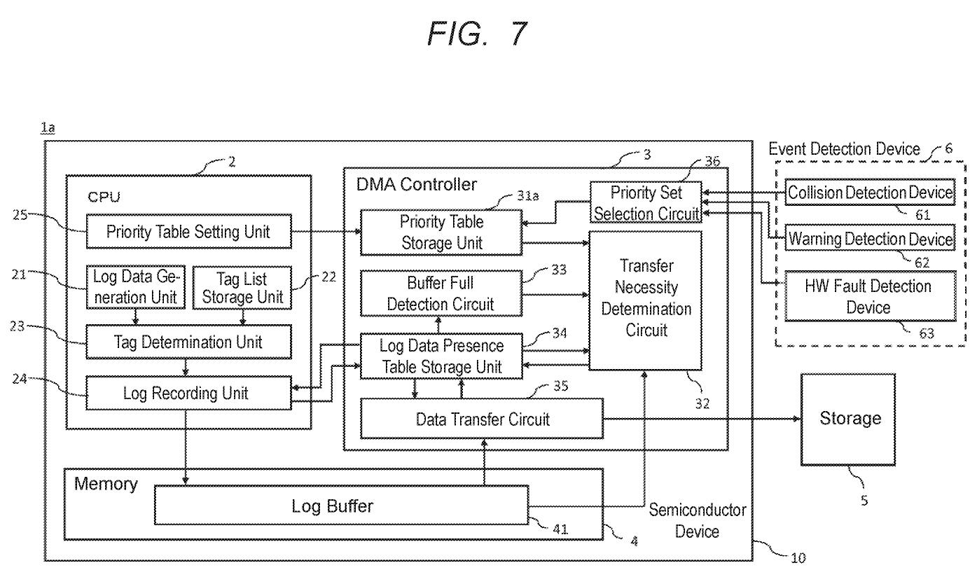

FIG. 7 is a block diagram illustrating a log management apparatus 1a according to the second embodiment. As shown in FIG. 7, the log management apparatus 1a according to the second embodiment includes, in addition to the configuration of the log management apparatus 1 according to the first embodiment, an event detection device 6 and a priority set selection circuit 36. Also, a priority table according to the second embodiment stored in a priority table storage unit 31a differs from the priority table according to the first embodiment in that it includes a plurality of priority sets and selection information for selecting a valid priority set.

The log management apparatus 1a is mounted on a vehicle as part of an in-vehicle system. However, the log management apparatus 1a is not limited to being completely integrated as part of the vehicle body. For example, the storage 5 may be in a form that can be separated from the vehicle body.

The event detection device 6 detects a plurality of events occurring in the vehicle to generate a plurality of event detection notifications. Each of the plurality of event detection notifications is generated according to the detected event. The event detection device 6 is connected to the priority set selection circuit 36 within the DMA controller 3 and outputs the generated plurality of event detection notifications to the priority set selection circuit 36.

As shown in FIG. 7, the event detection device 6 includes a collision detection device 61, a warning detection device 62, and a Hardware (HW) fault detection device 63. The collision detection device 61, warning detection device 62, and HW fault detection device 63 included in the event detection device 6 are examples, and the event detection device 6 may include devices other than the collision detection device 61, warning detection device 62, and HW fault detection device 63. Moreover, the event detection device 6 does not need to include all of the collision detection device 61, warning detection device 62, and HW fault detection device 63. Each of the collision detection device 61, warning detection device 62, and HW fault detection device 63 included in the event detection device 6 detects different events to output an event detection notification corresponding to the detected event.

The collision detection device 61 detects a collision of the vehicle to generate a collision detection notification. That is, the event detected by the collision detection device 61 is a vehicle collision, and the event detection notification generated by the collision detection device 61 becomes a collision detection notification. The collision detection device 61 outputs the collision detection notification to the priority set selection circuit 36 at the timing when it wants to execute the switching of the priority set.

The warning detection device 62 detects a state where the risk of an accident occurring with the vehicle increases, such as the presence of obstacles on the road or the driver falling asleep, to generate a warning detection notification. That is, the event detected by the warning detection device 62 is a state where the risk of an accident occurring with the vehicle increases, and the event detection notification generated by the warning detection device 62 becomes a warning detection notification. The warning detection device 62 outputs the warning detection notification to the priority set selection circuit 36 at the timing when it wants to execute the switching of the priority set.

The HW fault detection device 63 detects the occurrence of a fault in the HW mounted on the vehicle to generate an HW fault detection notification. That is, the event detected by the HW fault detection device 63 is the occurrence of a fault in the HW mounted on the vehicle, and the event detection notification generated by the HW fault detection device 63 becomes an HW fault detection notification. The HW fault detection device 63 outputs the HW fault detection notification to the priority set selection circuit 36 at the timing when it wants to execute the switching of the priority set.

In the description of the embodiment, the event detection device 6 indicates the entire device including the collision detection device 61, warning detection device 62, and HW fault detection device 63, and is intended to collectively indicate the included devices. Therefore, when expressed as the event detection device 6, it indicates all or any one of the collision detection device 61, warning detection device 62, and HW fault detection device 63. Also, the event detection notification indicates the entire notification including the collision detection notification, warning detection notification, and HW fault detection notification, and is intended to collectively indicate the included notifications. Therefore, when expressed as the event detection notification, it indicates all or any one of the collision detection notification, warning detection notification, and HW fault detection notification.

The priority set selection circuit 36 is included in the DMA controller 3 and is connected to the event detection device 6 and the priority table storage unit 31a. The priority table storage unit 31a stores a priority table including a plurality of priority sets and selection information. The priority set selection circuit 36 selects, from among the plurality of priority sets included in the priority table, a priority set according to the output status of a plurality of event detection notifications from the event detection device 6, and sets the selection information indicating that the selected priority set is a valid priority set in the priority table. As a result, when the transfer necessity determination circuit 32 accesses the priority table according to the second embodiment, it can identify the currently valid priority set from among the plurality of priority sets by referring to the selection information.

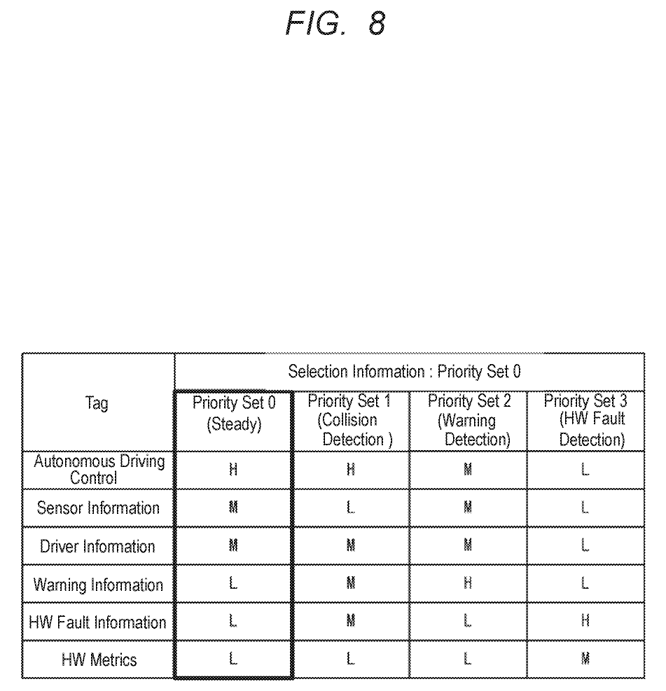

FIG. 8 is a diagram for explaining an example of the priority table according to the second embodiment. As shown in FIG. 8, the priority table includes priority sets 0 to 3. The priority set 0 is a priority set selected as the valid priority set in a steady state. The priority set 1 is a priority set selected as the valid priority set in a collision detection state. The priority set 2 is a priority set selected as the valid priority set in a warning detection state. The priority set 3 is a priority set selected as the valid priority set in an HW fault detection state.

The steady state indicates a state where no event is detected in the event detection device 6, and no event detection notification is output. The collision detection state indicates a state where a collision detection notification is output from the collision detection device 61. The warning detection state indicates a state where a warning detection notification is output from the warning detection device 62. The HW fault detection state indicates a state where an HW fault detection notification is output from the HW fault detection device 63. In the description of the embodiment, the steady state, collision detection state, warning detection state, and HW fault detection state are collectively referred to as an event state. Therefore, when expressed as an event state, it indicates all or any one of the steady state, collision detection state, warning detection state, and HW fault detection state.

The priority set selection circuit 36, when in a steady state, that is, when none of the collision detection notification, warning detection notification, and HW fault detection notification are received, selects the priority set 0 from among the priority sets 0 to 3 included in the priority table. The priority set selection circuit 36 sets the selection information indicating that the priority set 0 is the valid priority set in the priority table. Note that FIG. 8 shows a state where the priority set 0 is selected as the valid priority set.

The priority set selection circuit 36, when in a collision detection state, that is, when a collision detection notification is received, selects the priority set 1 from among the priority sets 0 to 3 included in the priority table. The priority set selection circuit 36 sets the selection information indicating that the priority set 1 is the valid priority set in the priority table.

The priority set selection circuit 36, when in a warning detection state, that is, when a warning detection notification is received, selects the priority set 2 from among the priority sets 0 to 3 included in the priority table. The priority set selection circuit 36 sets the selection information indicating that the priority set 2 is the valid priority set in the priority table.

The priority set selection circuit 36, when in an HW fault detection state, that is, when an HW fault detection notification is received, selects the priority set 3 from among the priority sets 0 to 3 included in the priority table. The priority set selection circuit 36 sets the selection information indicating that the priority set 3 is the valid priority set in the priority table.

In this manner, the priority set selection circuit 36 selects a priority set according to the steady state from among the plurality of priority sets included in the priority table when it is in a steady state where no event detection notification is received from the event detection device 6. Additionally, when the priority set selection circuit 36 receives any of the plurality of event detection notifications from the event detection device 6, it selects, from among the plurality of priority sets included in the priority table, a priority set according to the event detection notification of the plurality of event notifications received from the event detection device 6.

The priority table shown in FIG. 8 illustrates six types of tags (autonomous driving control tag, sensor information tag, driver information tag, warning information tag, HW fault information tag, HW metrics tag) as tags associated with log data. These tags are related to events detected by the event detection device 6.

The autonomous driving control tag is a tag associated with log data related to the control of autonomous driving. The sensor information tag is a tag associated with log data related to sensing information from cameras, radar, and Light Detection And Ranging (LIDAR) that sense the surroundings of the vehicle. The driver information tag is a tag associated with log data related to the state of the driver. For example, the state of the driver is obtained by a camera on the driver's side, such as a Driver Monitoring System (DMS). The warning information tag is a tag associated with log data related to warning information generated in conjunction with control systems such as the driving control system. The HW fault information tag is a tag associated with log data related to HW faults. The log data related to HW faults includes data indicating that each module, such as a camera, has failed. The HW metrics tag is a tag associated with log data indicating analog signals output from HW or the number of times HW has been used.

The priority for each tag included in the priority set shown in FIG. 8 is set using H, M, and L, similar to FIG. 3. In the priority set 0 selected in the steady state, the priority of the autonomous driving control tag is set to H, the priority of the sensor information tag and driver information tag is set to M, and the priority of the warning state tag, HW fault information tag, and HW metrics tag is set to L. Log data stored in the steady state is used, for example, to analyze the cause of transitioning to another event state by comparing it with log data stored in other event states. Log data associated with the autonomous driving control tag is important data for understanding the behavior of the entire vehicle, so the priority of the autonomous driving control tag is set to the highest. Log data associated with the sensor information tag and driver information tag is always changing even in the steady state and can be used as verification data for improving in-vehicle functions, so the priority of the sensor information tag and driver information tag is set to the next highest after the autonomous driving control tag. Log data associated with the warning state tag, HW fault information tag, and HW metrics tag is assumed to have no changes in the steady state, so the priority of the warning state tag, HW fault information tag, and HW metrics tag is set to the lowest.

In the priority set 1 selected in the collision detection state, the priority of the autonomous driving control tag is set to H, the priority of the driver information tag, warning information tag, and HW fault information tag is set to M, and the priority of the sensor information tag and HW metrics tag is set to L. Log data stored in the collision detection state is used, for example, to analyze why a collision occurred while the autonomous driving system was activated. Log data associated with the autonomous driving control tag includes data indicating the state, judgment results, and control results of the autonomous driving system. This data can be important for determining whether the autonomous driving system was operating normally before and after the collision, so the priority of the autonomous driving control tag is set to the highest. Log data associated with the driver information tag, warning information tag, and HW fault information tag includes data indicating whether the driver responded to warnings from the in-vehicle system, whether warnings were issued before the collision, and whether HW faults occurred. This data can be a factor in determining the validity of the autonomous driving control results, so the priority of the driver information tag, warning information tag, and HW fault information tag are set to the next highest after the autonomous driving control tag. Log data associated with the sensor information tag and HW metrics tag is not directly necessary for determining the operation of the autonomous driving system, so the priority of the sensor information tag and HW metrics tag is set to the lowest.

In the priority set 2 selected in the warning detection state, the priority of the warning information tag is set to H, the priority of the autonomous driving control tag, sensor information tag, and driver information tag is set to M, and the priority of the HW fault information tag and HW metrics tag is set to L. Log data stored in the warning detection state is used, for example, to verify and improve the operation and performance of the warning system. Log data associated with the warning information tag becomes data for identifying the type of warning issued, so the priority of the warning information tag is set to the highest. Log data associated with the autonomous driving control tag, sensor information tag, and driver information tag includes data indicating the judgment results of the autonomous driving system that triggered the warning, the situation around the vehicle, and the state of the driver. This data can be verification data for improving the functionality of the warning system, so the priority of the autonomous driving control tag, sensor information tag, and driver information tag is set to the next highest after the warning information tag. When the in-vehicle system is operating normally, it is assumed that the HW is normal, so the usability of data associated with the HW fault information tag and HW metrics tag is low. Therefore, the priority of the HW fault information tag and HW metrics tag is set to the lowest.

In the priority set 3 selected in the HW fault detection state, the priority of the HW fault information tag is set to H, the priority of the HW metrics tag is set to M, and the priority of the autonomous driving control tag, sensor information tag, driver information tag, and warning information tag is set to L. Log data stored in the HW fault detection state is used, for example, to identify that an HW fault has been detected and to understand precursor signals related to the occurrence of HW faults. Log data associated with the HW fault information tag becomes data for identifying the faulty HW, so the priority of the HW fault information tag is set to the highest. Log data associated with the HW metrics tag is useful for analyzing the cause of the fault and precursors to the fault, so the priority of the HW metrics tag is set to the next highest after the HW fault information tag. Although log data associated with the autonomous driving control tag, sensor information tag, driver information tag, and warning information tag can contribute to identifying the faulty HW and analyzing the cause of the fault, their importance is lower than that of the log data associated with the HW fault information tag and HW metrics tag. Therefore, the priority of the autonomous driving control tag, sensor information tag, driver information tag, and warning information tag is set to the lowest.

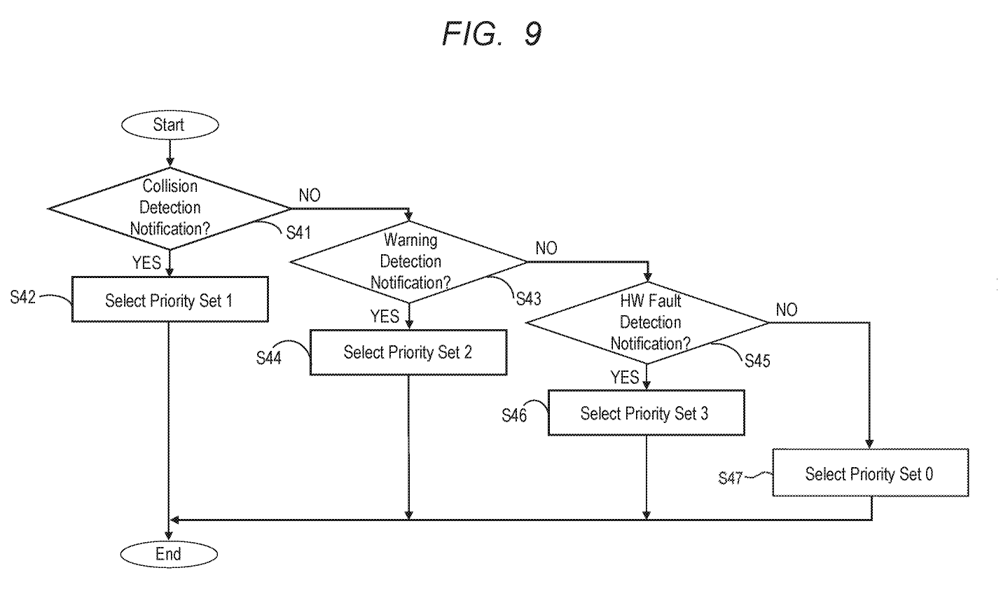

Next, the operation of the priority set selection circuit 36 will be described with reference to FIG. 9. FIG. 9 is a flowchart illustrating the operation of the priority set selection circuit 36 according to the second embodiment. First, at the start of the flowchart in FIG. 9, that is, during the startup process of the log management apparatus 1a, the priority table setting unit 25 performs the initial setting of the priority table. In the initial setting of the priority table, a plurality of priority sets and selection information as shown in FIG. 8 are set in the priority table. The selection information at the time of initial setting indicates that the priority set 0 is the valid priority set.

In a step S41, the priority set selection circuit 36 confirms whether it has received a collision detection notification from the collision detection device 61. If the priority set selection circuit 36 confirms that it has received the collision detection notification (YES in the step S41), the process proceeds to a step S42. On the other hand, if the priority set selection circuit 36 confirms that it has not received the collision detection notification (NO in the step S41), the process proceeds to a step S43.

In the step S42, the priority set selection circuit 36 selects the priority set 1. The priority set selection circuit 36 accesses the priority table storage unit 31a and sets selection information indicating that the priority set 1 is a valid priority set in the priority table.

In the step S43, the priority set selection circuit 36 confirms whether it has received a warning detection notification from the warning detection device 62. If the priority set selection circuit 36 confirms that it has received the warning detection notification (YES in the step S43), the process proceeds to a step S44. On the other hand, if the priority set selection circuit 36 confirms that it has not received the warning detection notification (NO in the step S43), the process proceeds to a step S45.

In the step S44, the priority set selection circuit 36 selects the priority set 2. The priority set selection circuit 36 accesses the priority table storage unit 31a and sets selection information indicating that the priority set 2 is a valid priority set in the priority table.

In the step S45, the priority set selection circuit 36 confirms whether it has received an HW fault detection notification from the HW fault detection device 63. If the priority set selection circuit 36 confirms that it has received the HW fault detection notification (YES in the step S45), the process proceeds to a step S46. On the other hand, if the priority set selection circuit 36 confirms that it has not received the HW fault detection notification (NO in the step S45), the process proceeds to a step S47.

In the step S46, the priority set selection circuit 36 selects the priority set 3. The priority set selection circuit 36 accesses the priority table storage unit 31a and sets selection information indicating that the priority set 3 is a valid priority set in the priority table.

In the step S47, the priority set selection circuit 36 selects the priority set 0. The priority set selection circuit 36 accesses the priority table storage unit 31a and sets selection information indicating that the priority set 0 is a valid priority set in the priority table. The state of step S47 corresponds to a state in which the event detection notification is not output from the event detection device 6, since the results of all the conditional branches of the steps S41, S43, and S45 are NO.

If the event detection device 6 includes a plurality of detection devices, it is conceivable that a plurality of event detection notifications may be output simultaneously from the event detection device 6. For example, in the event detection device 6 illustrated in FIG. 7, it is possible for two or more notifications among the collision detection notification, warning detection notification, and HW fault detection notification to be output simultaneously. Which event detection notifications are prioritized when selecting the priority set depends on the purpose of the analysis.

In the operation example of the priority set selection circuit 36 shown in FIG. 9, the output status of the collision detection notification is first confirmed in the step S41, followed by the output status of the warning detection notification in the step S43, and finally the output status of the HW fault detection notification in the step S45. The order of confirming event detection notifications shown in FIG. 9 is suitable for cases where priority is given to the analysis of the state after collision detection and the identification of the cause of the collision. That is, after collision detection, by selecting the priority set 1, appropriate log data corresponding to the collision detection state can be saved. Before collision detection, by selecting the priority set 2, appropriate log data corresponding to the warning detection state can be saved.

Moreover, although the step of confirming the output status of the HW fault detection notification is last in the example of FIG. 9, the timing of confirming the output status of the HW fault detection notification may change if the analysis purpose changes. For instance, if the analysis purpose is to verify HW faults after collision detection, it may be changed to confirm the output status of the HW fault detection notification first.

The selection information set by the priority set selection circuit 36 is used when the transfer necessity determination circuit 32 reads the priority set from the priority table. That is, the transfer necessity determination circuit 32 refers to the selection information to identify the currently valid priority set when reading the priority set. The transfer necessity determination circuit 32 reads the priority set identified by the selection information from the priority table. The other operations of the log management apparatus 1a according to the second embodiment are the same as those of the log management apparatus 1 according to the first embodiment.

As described above, the log management apparatus 1a according to the second embodiment achieves the same effect as the log management apparatus 1 according to the first embodiment by determining the log data not to be transferred to the storage 5 from among the log data stored in the log buffer 41 based on the priority set included in the priority table.

Furthermore, the log management apparatus 1a according to the second embodiment selects a priority set according to the output status of event detection notifications from among the plurality of priority sets included in the priority table and sets selection information indicating that the selected priority set is a valid priority set. This allows dynamic switching of priority sets, enabling the storage of desired log data according to the event detection state.

### Third Embodiment

A third embodiment will be described. As mentioned above, the log data stored in a steady state is compared with the log data stored in other event states when analyzing the cause of transitioning to another event state. However, in the log management apparatus according to the second embodiment, the priority set selected in the steady state was fixed to the priority set 0. In this case, it may not be possible to obtain the log data in a steady state, which is the subject of comparison, appropriately. For example, in the case of the priority set 0 shown in FIG. 8, the priority of the warning state tag, HW fault information tag, and HW metrics tag is set to the lowest, so the log data associated with these tags may not be transferred to the storage 5 at all, depending on the configuration and performance of the in-vehicle system. Therefore, in the log management apparatus according to the third embodiment, it is configured to allow switching of the priority set selected in the steady state.

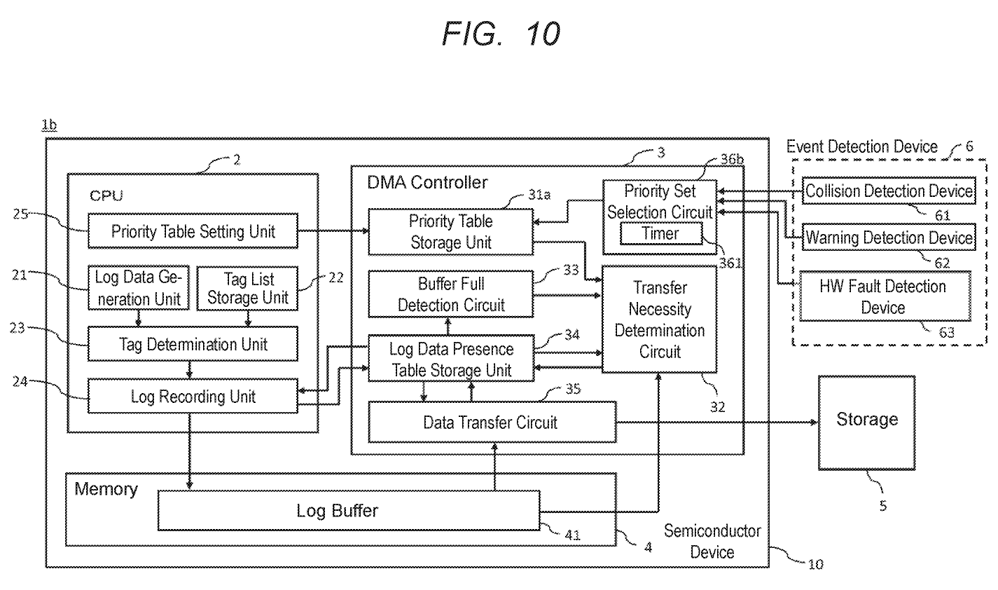

FIG. 10 is a block diagram illustrating a log management apparatus 1b according to the third embodiment. The log management apparatus 1b according to the third embodiment differs from the log management apparatus 1a according to the second embodiment in a priority set selection circuit 36b. As shown in FIG. 10, the priority set selection circuit 36b of the log management apparatus 1b includes a timer 361. The timer 361 starts a timing operation after setting a specified time and generates a match signal when the specified time is reached.

The priority set selection circuit 36b sets the specified time in the timer 361 and activates the timer 361 in the steady state. When a match signal is generated in the timer 361, the priority set selection circuit 36b switches the priority set selected in the steady state by changing the selection information in the priority table. After changing the selection information, the priority set selection circuit 36b initializes the count value of the timer 361 and activates the timer 361 again. In this way, the priority set selection circuit 36b switches the priority set selected in the steady state at regular intervals based on the match signal from the timer 361. Note that when an event detection notification is received, the priority set selection circuit 36b stops the switching operation of the priority set using the timer 361 and selects the priority set according to the received event detection notification. This point is the same as in the second embodiment.

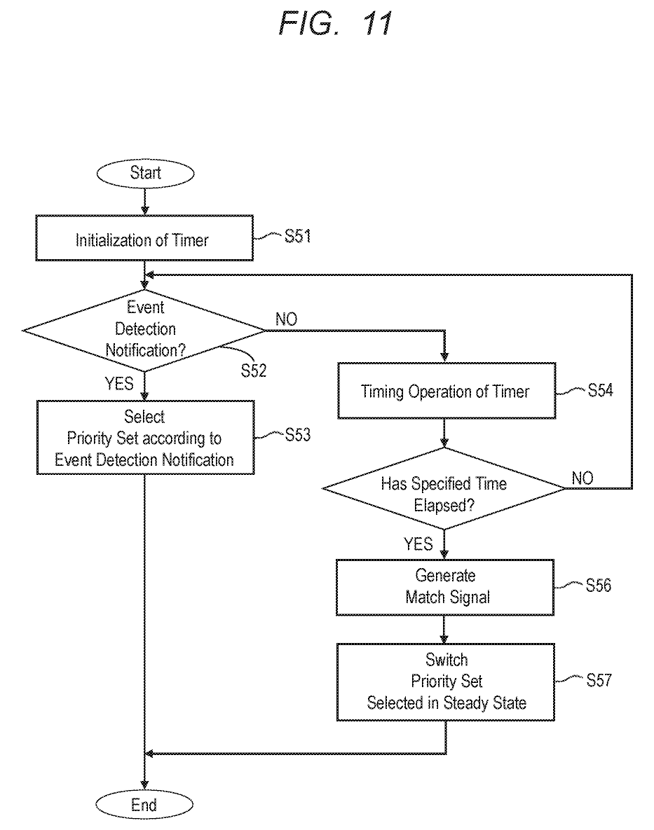

Next, the operation of the priority set selection circuit 36b will be described with reference to FIG. 11. FIG. 11 is a flowchart illustrating the operation of the priority set selection circuit 36b according to the third embodiment. In a step S51, the priority set selection circuit 36b performs the initialization process of the timer 361. Specifically, the priority set selection circuit 36b initializes the count value of the timer 361 and sets the specified time.

In a step S52, the priority set selection circuit 36b confirms whether an event detection notification output from the event detection device 6 has been received. If the priority set selection circuit 36b confirms that an event detection notification has been received (YES in the step S52), the process proceeds to a step S53. On the other hand, if the priority set selection circuit 36b confirms that no event detection notification has been received (NO in the step S52), the process proceeds to a step S54.

In the step S53, the priority set selection circuit 36b selects the priority set according to the event detection notification. The selection operation of the priority set according to the event detection notification is the same as in the second embodiment. That is, the step S52 in FIG. 11 corresponds to the steps S41, S43, and S45 in FIG. 9, and the step S53 in FIG. 11 corresponds to the steps S42, S44, and S46 in FIG. 9.

In the step S54, the timer 361 performs a timing operation. For example, if the timer 361 is configured by an up-counter, the timer 361 increments the count value by one.

In a step S55, the timer 361 determines whether the specified time has elapsed by comparing the count value with the specified time. If the timer 361 determines that the specified time has elapsed (YES in the step S55), the process proceeds to a step S56. On the other hand, if the timer 361 determines that the specified time has not elapsed (NO in the step S55), the process returns to the step S52. In other words, the processes of the steps S52 and S54 are repeated until it is determined that the specified time has elapsed.

In the step S56, the timer 361 generates a match signal.

In a step S57, the priority set selection circuit 36b switches the priority set selected in the steady state based on the generation of the match signal. For example, the switching of the priority set is performed by selecting a priority set other than the currently selected priority set from among the priority sets 0 to 3. In this case, the priority set selected in the steady state may be switched in the order of the priority set 0, priority set 1, priority set 2, and priority set 3. The priority set selection circuit 36b accesses the priority table storage unit 31a and sets the selection information of the priority table so that the desired priority set is selected as the valid priority set.

Thus, in the step S57, if the priority set selection circuit 36b is in a steady state where none of the plurality of event detection notifications from the event detection device 6 are received, it selects a different priority set from among the priority sets 0 to 3 including the priority sets 1 to 3 selected according to any of the plurality of event detection notifications each time a match signal is generated by the timer 361.

The switching of the priority set in the step S57 is not limited to the aforementioned method. For example, it is also possible to set a plurality of priority sets, which are selected only in a steady state, in the priority table. Specifically, in addition to the priority sets 0 to 3, a priority set 4, which is selected in a steady state, can be added to the priority table. As a result, the priority sets 0 and 4 become the priority sets selected in a steady state where none of the plurality of event detection notifications are received, and each of the priority sets 1 to 3 becomes the priority set selected according to any of the plurality of event detection notifications. The priority set selection circuit 36b, in a steady state where none of the plurality of event detection notifications are received from the event detection device 6, selects a different priority set from among the priority sets 0 and 4 each time a match signal is generated by the timer 361.

As described above, the log management apparatus 1b according to the third embodiment achieves the same effect as the log management apparatus 1 according to the first embodiment and the log management apparatus 1a according to the second embodiment, by determining the log data not to be transferred to the storage 5 from among the log data stored in the log buffer 41 based on the priority set included in the priority table.

Furthermore, the log management apparatus 1b according to the third embodiment, in a steady state where none of the plurality of event detection notifications are received, selects a different priority set from among the plurality of priority sets included in the priority table each time a match signal is generated by the timer 361. This allows the desired log data to be stored in a steady state.

Although the invention made by the present inventor has been specifically described based on the embodiment, the present invention is not limited to the above-described embodiment, and it is needless to say that various modifications can be made without departing from the gist thereof.

What is claimed is:

1. A log management apparatus for transferring log data to a storage, comprising:
a Central Processing Unit (CPU) that outputs log data;
a log buffer that is coupled to the CPU, and that stores log data before being transferred to the storage; and
a Direct Memory Access (DMA) controller that is coupled to the log buffer and the storage, and that transfers the log data stored in the log buffer to the storage,
wherein the DMA controller includes:
a priority table storage unit that stores a priority table including a priority set that determines a priority for each tag associated with log data; and
when it is determined that there is insufficient space to write log data in the log buffer, a transfer necessity determination circuit that determines which log data not to be transferred to the storage from among the log data stored in the log buffer based on the priority set.

2. The log management apparatus according to claim 1,
wherein the DMA controller includes a log data presence table storage unit that stores a log data presence table including addresses of the log buffer and flags associated with the addresses of the log buffer,
wherein each of the flags indicates whether log data to be transferred to the storage has been written to the address of the log buffer associated with the flag, and
Wherein The transfer necessity determination circuit:
Determines, as a non-transfer address, an address of the log buffer storing the log data that is not to be transferred to the storage from among the log data stored in the log buffer; and
changes a value of a flag associated with the address of the log buffer determined as the non-transfer address from a first value to a second value.

3. The log management apparatus according to claim 2,
wherein the log buffer stores the log data, and tags associated with the log data, and
wherein the transfer necessity determination circuit:
obtains the priority for each tag from the priority set included in the priority table, and identifies at least one tag as a low-priority tag by referring to an obtained priority for each tag;
obtains an address of the log buffer associated with a flag set to the first value in the log data presence table, and reads a tag stored in the log buffer using an obtained address of the log buffer; and
compares a read tag with the low-priority tag to determine, as non-transfer address, the address of the log buffer where the low-priority tag is read.

4. The log management apparatus according to claim 2,
wherein the DMA controller includes a buffer full detection circuit that monitors the flags in the log data presence table to generate a buffer full signal to warn of insufficient space for writing log data in the log buffer, and
wherein the transfer necessity determination circuit determines that there is insufficient space for writing the log data in the log buffer in response to a generation of the buffer full signal.

5. The log management apparatus according to claim 2,
wherein the CPU includes a log recording unit that writes the log data before being transferred to the storage into the log buffer, and
wherein, after a completion of writing log data into the log buffer, the log recording unit sets the first value in a flag associated with an address of the log buffer where writing has been completed in the log data presence table.

6. The log management apparatus according to claim 2,
wherein the DMA controller includes a data transfer circuit that transfers the log data stored in the log buffer to the storage, and
wherein the data transfer circuit:
obtains an address of the log buffer associated with a flag set to the first value in the log data presence table, and reads the log data using an obtained address of the log buffer;
transfers a read log data to the storage; and
after a completion of transferring the log data to the storage, changes, from the first value to the second value, a value of the flag associated with the address of the log buffer where the log data transferred to the storage is stored in the log data presence table.

7. The log management apparatus according to claim 1, further comprising the storage that coupled to the DMA controller and that stores the log data output from the DMA controller.

8. The log management apparatus according to claim 1, further comprising an event detection device that detects a plurality of events to generate a plurality of event detection notifications,
wherein each of the plurality of event detection notifications is generated according to a detected event,
wherein the priority table includes a plurality of priority sets including the priority set and selection information for selecting a valid priority set,
wherein the DMA controller includes a priority set selection circuit that is coupled to the event detection device, and that receives the plurality of event detection notifications,
wherein the priority set selection circuit selects a priority set according to the output status of the plurality of event detection notifications from among the plurality of priority sets, and sets the selection information indicating that a selected priority set is a valid priority set, and
wherein the transfer necessity determination circuit identifies a valid priority set by referring to the selection information.

9. The log management apparatus according to claim 8, wherein the priority set selection circuit selects, from among the plurality of priority sets, a priority set according to an event detection notification of the plurality of event detection notifications received from the event detection device.

10. The log management apparatus according to claim 8, wherein, when in a steady state where none of the plurality of event detection notifications are received from the event detection device, the priority set selection circuit selects, from among the plurality of priority sets, a priority set according to the steady state.

11. The log management apparatus according to claim 8,
wherein the priority set selection circuit includes a timer that starts a timing operation after setting a specified time, and that generates a match signal when the specified time is reached,
wherein the plurality of priority sets includes first to third priority sets,
wherein each of the first and second priority sets is a priority set selected according to any of the plurality of event detection notifications, and
wherein, when in a steady state where none of the plurality of event detection notifications are received from the event detection device, the priority set selection circuit selects, from among the first to third priority sets, a different priority set each time the match signal is generated.

12. The log management apparatus according to claim 8,
wherein the priority set selection circuit includes a timer that starts a timing operation after setting a specified time, and that generates a match signal when the specified time is reached,
wherein the plurality of priority sets includes first to fourth priority sets,
wherein each of the first and second priority sets is a priority set selected according to any of the plurality of event detection notifications, and
wherein, when in a steady state where none of the plurality of event detection notifications are received from the event detection device, the priority set selection circuit selects, from among the third and fourth priority sets, a different priority set each time the match signal is generated.

13. An in-vehicle system mounted on a vehicle, comprising the log management apparatus according to claim 1.

14. An in-vehicle system mounted on a vehicle, comprising the log management apparatus according to claim 8,
wherein the event detection device includes a collision detection device, a warning detection device, and a Hardware (HW) fault detection device,
wherein the plurality of event detection notifications includes a collision detection notification, a warning detection notification, and an HW fault detection notification,
wherein the collision detection device detects a state where the vehicle has collided to generate the collision detection notification,
wherein the warning detection device detects a state where a risk of an accident occurring with the vehicle increases to generate the warning detection notification, and
wherein the HW fault detection device detects an occurrence of a fault in the HW mounted on the vehicle to generate the fault detection notification.

15. A data transfer method for a log management apparatus that transfers log data output from a CPU to a storage, the data transfer method comprising:
storing log data before being transferred to the storage in a log buffer;
transferring the log data stored in the log buffer to the storage;
storing a priority table including a priority set that determines a priority for each tag associated with log data in a priority table storage unit; and
when it is determined that there is insufficient space to write log data in the log buffer, determining which log data not to be transferred to the storage from among the log data stored in the log buffer based on the priority set.

16. The data transfer method for the log management apparatus according to claim 15, further comprising:
storing, in a log data presence table storage unit, a log data presence table including addresses of the log buffer and flags associated with the addresses of the log buffer;
determining, as a non-transfer address, an address of the log buffer storing the log data that is not to be transferred to the storage from among the log data stored in the log buffer; and
changing a value of a flag associated with the address of the log buffer determined as the non-transfer address from a first value to a second value,
wherein each of the flags set to the first value indicates that log data to be transferred to the storage has been written to an address of the log buffer associated with the flag set to the first value, and
wherein each of the flags set to the second value indicates that log data to be transferred to the storage has not been written to an address of the log buffer associated with the flag set to the second value.
